(19) United States
(12) Patent Application Publication
(10) Pub. No.: US 2020/0310587 A1
(43) Pub. Date: Oct. 1, 2020

(54) TOUCH-INPUT COMPUTING DEVICE WITH OPTIMIZED TOUCH OPERATION AND METHOD THEREOF

(71) Applicant: Shenzhen Fugui Precision Ind. Co., Ltd., Shenzhen (CN)

(72) Inventor: CHIH-BIN HUANG, New Taipei (TW)

(21) Appl. No.: 16/365,233

(22) Filed: Mar. 26, 2019

(51) Int. Cl. G06F 3/041; G06F 3/0488; G06F 3/0484

(52) U.S. Cl. CPC G06F 3/0418; G06F 3/04845; G06F 3/04886

(57) ABSTRACT

A method for optimizing touch controls on an interface of a touch-input computing device having a touch screen comprises the displaying of a zone on the touch screen and setting internal and external boundary sensing regions of the zone for the purpose of receiving and recognizing touch operations from a user. The touch-input computing device determines whether an initial contact point of the touch operation is located within the internal or external boundary sensing regions and if so deems such touch to be made on the boundary line, carrying out such resizing or other command accordingly.

### FIELD

The subject matter herein generally relates to human-computer interfaces.

### BACKGROUND

Some applications allow users to move and resize components located in a graphical user interface. For example, a user can touch and drag within a zone. The zone can be dragged to a position as needed, or touch and drag at the boundary of the zone to resize the zone.

The boundary of the zone, being narrow, may be difficult to operate. Difficulties in operating the boundary of the zone may affect user experience.

### BRIEF DESCRIPTION OF THE DRAWINGS

Implementations of the present technology will now be described, by way of example only, with reference to the attached figures, wherein:

FIG. 1 is a block diagram of one embodiment of a touch-input computing device.

FIG. 2 is a flow chart of one embodiment of a method for optimizing touch operation applied to the device of FIG. 1.

FIG. 3 is a schematic diagram showing an application of the method in one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one”.

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series, and the like.

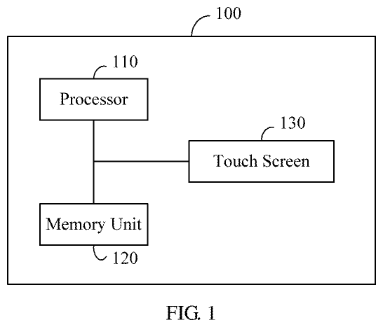

FIG. 1 illustrates a touch-input computing device 100 according to an embodiment. The touch-input computing device 100 comprises a processor 110, a memory unit 120, and a touch screen 130. The touch-input computing device 100 is, for example, a portable computing device, a tablet computing device, a personal computer, a smart mobile phone, a user terminal device, a wireless device, and/or other touch-input computing device. The processor 110 is electrically connected to the memory unit 120 and he touch screen 130. The processor 110 can be a microcontroller, microprocessor, or other similar device configured to execute or process instructions, data, and computer programs stored in the memory unit 120 to control the operation of the touch-input computing device 100. The memory unit 120 is a computer readable storage medium, such as random access memory (RAM), non-volatile memory (e.g., any one or more of read-only memory (ROM), flash memory, EPROM, EEPROM, etc.), and any type of magnetic or optical storage device. The touch screen 130 can sense a touch input, for example, user's one or more fingers touching in a graphical user interface displayed on the touch screen 130. The touch screen 130 is combined with the touch-input computing device 100 in FIG. 1. In other embodiment, the touch screen 130 can be a separate device communicatively coupled to the touch-input computing device 100 in a wired and/or wireless connection.

The user interface of the touch-input computing device 100 is based on touch operations. The touch-input computing device 100 presents a graphical user interface on the touch screen 130 and receives the user's input through the touch screen 130. The graphical user interface may be a graphical user interface preset by the touch-input computing device 100 or a graphical user interface that appears after the user clicks on one application. In one embodiment, the graphical user interface comprises at least one zone as an interface window. In another embodiment, the zone can be used to display all or part of the content of one application, or a pop-up menu, or the like. The shape of the zone may be, but is not limited to, a circle, a triangle, a rectangle, or a polygon. Taking the shape of the zone as a rectangle, the block comprise four boundaries, which are an upper boundary, a lower boundary, and left and right boundaries. In one embodiment, the touch-input computing device 100 allows the user to touch and drag on the boundary of the zone, to resize the zone. The user action can make more content can be revealed inside the zone after the zone is resized. In such situation, the presented content of the zone is re-adjusted according to the resizing, and the content of the graphical user interface remains unchanged. In another embodiment, the touch-input computing device 100 also allows the user to touch and drag the entire zone by touching any point of the interior of the zone. In such situation, the presented content of the zone remains unchanged, even in a differently-located zone.

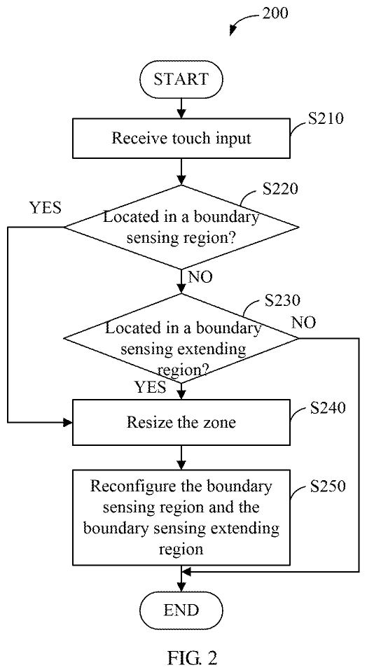

FIG. 2 illustrates a flow 200 of a method for optimization of touch operation by the touch-input computing device 100 according to an embodiment. It should be noted that the sequence of steps illustrated in FIG. 2 is merely an example. In another embodiment, any of the steps may be randomly arranged to form different process flows. Generally, when the user needs to resize the zone, the user firstly touches on the boundary of the zone and then performs a drag operation, but sometimes the contact point of user's finger on the touch screen 130 is not precisely on the boundary of the zone, the contact point may be slightly outside or inside the zone, so that the desired result of touch operation is not achieved.

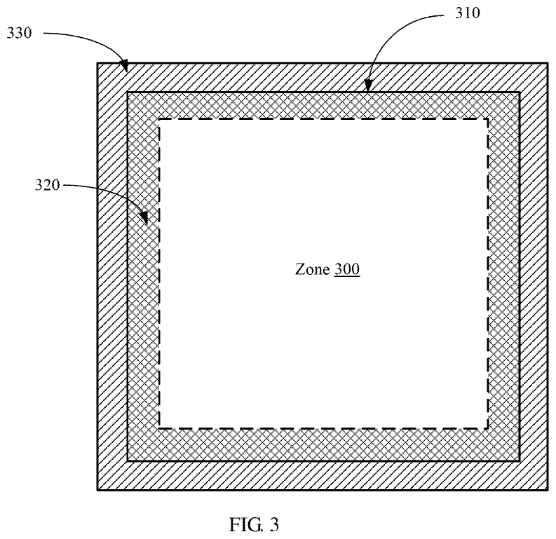

FIG. 3 illustrates an example of a zone 300. In an embodiment, a boundary sensing region 320 is configured in the interior of the zone 300, and a boundary sensing extending region 330 is configured on the outside of the zone 300. As long as the user's touch point of the touch screen 130 is located within the boundary sensing region 320 or located within the boundary sensing extending region 330, a touch so made is deemed made on the boundary 310, to improve the hit rate of the boundary 310. Specifically, the size of the boundary sensing region 320 may be consistent with or different from the size of the boundary sensing extending region 330. In the embodiment, the respective areas of the boundary sensing region 320 and the boundary sensing extending region 330 are in a predetermined proportional relationship with the area of the zone 300. Further, the touch-input computing device 100 can set different boundary sensing regions according to the needs of different applications, and set the relationship between the boundary sensing region and the zone. The user can also manually change the preset proportional relationship to the actual required value according to actual needs. The steps of the process 200 are specifically described below in conjunction with FIG. 3.

At step S210, the touch-input computing device 100 receives the touch input of the user from the touch screen 130 and recognizes the operation as a touch input. The touch input comprises a single touch signal or a plurality of touch signals. In the embodiment, the operation is recognized by the plurality of touch signals formed by the continuous touch signals, for example, when the plurality of touch signals are continuous touches that form a specific track on the touch screen 130, it can be recognized as a drag operation.

At step S220, the touch-input computing device 100 determines whether the initial contact point of the drag operation on the touch screen 130 located within the boundary sensing region 320. If it is located within the boundary sensing region 320, step S240 is performed; otherwise, step S230 is executed.

At step S230, the touch-input computing device 100 further determines whether the initial contact point of the drag operation on the touch screen 130 located within the boundary sensing extending region 330. If it is located within the boundary sensing extending region 330, step S240 is executed; otherwise, the process 200 is ended.

At step S240, the touch-input computing device 100 resizes the zone 300 accordingly in response to the drag operation.

At step S250, the touch-input computing device 100 reconfigures the boundary sensing region 320 and the boundary sensing extending region 330 corresponding to the resizing of the zone 300. Specifically, the touch-input computing device 100 reconfigures the boundary sensing region 320 and the boundary sensing extending region 330 according to the area of the resized zone 300 and the proportional relationship.

In an embodiment, when the touch-input computing device 100 determines that the initial contact point of the drag operation is not located within the boundary sensing region 320 nor located within the boundary sensing extending region 330, the touch-input computing device 100 further determines whether the initial contact point is located within the interior of the zone 300. If it is located within the interior of zone 300, in response to the drag operation, the touch-input computing device 100 repositions the entire zone 300 accordingly.

It should be understood that, in the above embodiments, the finger-based touch operations can be carried out by any other form of user-initiated input action to the touch screen 130, with stylus or the like.

The touch-input computing device 100 dynamically resizes the boundary sensing region 320 and the boundary sensing extending region 330 corresponding to the resizing of the zone 300, thus optimizing touch operations on boundaries of the zone 300 to improve user experience.

The embodiments shown and described above are only examples. Many details are often found in the art such as the other features of a touch-input computing device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A touch-input computing device with optimized touch operation, comprising:
a touch screen;
a processor;
a memory unit for storing instructions, wherein the instructions are executed by the processor, and performs the following steps:
presenting a zone on the touch screen;
configuring a boundary sensing region which is extended from a boundary of the zone and is located inside the zone;
configuring a boundary sensing extending region which is extended from the boundary of the zone and is located outside of the zone;
receiving and recognizing a touch operation on the touch screen;
determining whether an initial contact point of the touch operation is located within the boundary sensing region;
resizing the zone according to the touch operation and reconfiguring the boundary sensing region when the initial contact point is located within the boundary sensing region;
when the initial contact point is not located within the boundary sensing region, further determining whether the initial contact point is located within the boundary sensing extending region;
resizing the zone according to the touch operation and reconfiguring the boundary sensing region and the boundary sensing extending region when the initial contact point is located within the boundary sensing extending region;
when the initial contact point is neither located within the boundary sensing region nor located in the boundary sensing extending region, further determining whether the initial contact point is located within an interior of the zone; and
repositioning the zone in response to the touch operation when the initial contact point is located within the interior of the zone.

2. (canceled)

3. (canceled)

4. The touch-input computing device of claim 1, wherein the touch operation is a drag operation.

5. The touch-input computing device of claim 1, wherein an area of the boundary sensing region is proportional to an area of the zone.

6. The touch-input computing device of claim 1, wherein an area of the boundary sensing extending region is proportional to an area of the zone.

7. A method for optimization of a touch operation applicable in a touch-input computing device comprising a touch screen, the method comprising the steps of:
presenting a zone on the touch screen;
configuring a boundary sensing region which is extended from a boundary of the zone and is located inside the zone;
configuring a boundary sensing extending region which is extended from the boundary of the zone and is located outside of the zone;
receiving and recognizing the touch operation on the touch screen;
determining whether an initial contact point of the touch operation is located within the boundary sensing region;
resizing the zone according to the touch operation and reconfiguring the boundary sensing region when the initial contact point is located within the boundary sensing region;
when the initial contact point is not located within the boundary sensing region, further determining whether the initial contact point is located within the boundary sensing extending region;
resizing the zone according to the touch operation and reconfiguring the boundary sensing region and the boundary sensing extending region when the initial contact point is located within the boundary sensing extending region;
when the initial contact point is neither located within the boundary sensing region nor located in the boundary sensing extending region, further determining whether the initial contact point is located within an interior of the zone; and
repositioning the zone in response to the touch operation when the initial contact point is located within the interior of the zone.

8. (canceled)

9. (canceled)

10. The method of claim 7, wherein the touch operation is a drag operation.

11. The method of claim 7, wherein an area of the boundary sensing region is proportional to an area of the zone.

12. The method of claim 7, wherein an area of the boundary sensing extending region is proportional to an area of the zone.
